(19) United States
(12) Patent Application Publication
(10) Pub. No.: US 2008/0295331 A1
(43) Pub. Date: Dec. 4, 2008

(54) Method and Apparatus for Inserting a Piston Pin Locking Ring

(75) Inventor: Siegfried Stemer, Satteins (AT)

Correspondence Address: LERNER GREENBERG STEMER LLP, P O BOX 2480, HOLLYWOOD, FL, 33022-2480, US

(73) Assignee: Mahle Konig Kommanditgesellschaft GmbH & Co., Rankweil (AT)

(21) Appl. No.: 12/098,500

(22) Filed: Apr. 7, 2008

Related U.S. Application Data
(63) Continuation of application No. PCT/AT2006/000404, filed on Oct. 4, 2006.

(30) Foreign Application Priority Data
Oct. 5, 2005 (AT) A 1632/2005

(51) Int. Cl. B21K 1/18; B23P 15/10

(52) U.S. Cl. 29/888.044; 29/222

(57) ABSTRACT

A process for inserting a piston pin locking ring, particular slotted snap ring, into a locking groove of a pin bore of a piston. The piston pin locking ring is radially pre-tightened and reduced in size in a first step in such a manner that its outside diameter becomes smaller than the inner diameter of the pin bore. The piston pin locking ring is subsequently introduced in the pre-tightened state into the pin bore without contact and without contacting the inner wall of the pin bore and is brought in position inside the pin bore in the area of the locking groove. Then the piston pin locking ring is freed by a relaxing and loosening of the tightening force and by springing into the locking groove and is thus fixed in place.

### CROSS-REFERENCE TO RELATED APPLICATIONS

This is a continuing application, under 35 U.S.C. § 120, of copending international application No. PCT/AT2006/000404, filed Oct. 4, 2006, which designated the United States; this application also claims the priority, under 35 U.S.C. § 119, of Austrian patent application No. A 1632/2005, filed Oct. 5, 2005; the prior applications are herewith incorporated by reference in their entirety.

### BACKGROUND OF THE INVENTION

### Field of the Invention

The invention relates to a method and a device for inserting a piston pin locking ring, in particular a slotted ring, into a groove of a pin bore of a piston.

In the previously known processes for inserting piston pin locking rings deformations or bucklings at the entrance to the or the formation of scratches can occur when pivoting in or pushing in the piston pin locking ring in the area of the inside of the pin bore. This can also result in the removal and/or chipping off of material. This problem can lead to engine problems.

### SUMMARY OF THE INVENTION

It is accordingly an object of the invention to provide a method and a device for inserting a piston pin locking ring, which overcomes the above-mentioned disadvantages of the heretofore-known devices and methods of this general type and which provides for a process and an apparatus for carrying out the process with which piston pin locking rings can be inserted in a piston without damaging the pin bore.

With the foregoing and other objects in view there is provided, in accordance with the invention, a method of inserting a piston pin locking ring into a locking groove of a pin bore in a piston, the method which comprises:

providing means for receiving, holding, and fixing the piston pin locking ring in a pre-tightened state and for transferring and introducing the pre-tightened piston pin locking ring into the pin bore, the means including a stop pin with a profiled stop pin tightening surface, and a tightening pin with a profiled tightening pin tightening surface;

radially pre-tightening and reducing a size of the piston pin locking ring until an outside diameter of the piston pin locking ring is smaller than an inner diameter of the pin bore;

holding and fixing the piston pin locking ring in a pre-tightened state between the tightening surface of the stop pin and the tightening surface of the tightening pin;

inserting the piston pin locking ring in the pre-tightened state into the pin bore substantially without contacting an inner wall of the pin bore, and moving the piston pin locking ring into position inside the pin bore at the locking groove formed in the pin bore; and

subsequently relieving and freeing the piston pin locking ring by relaxing and loosening a tightening force and allowing the piston pin locking ring to spring into the locking groove and to become fixed in place.

In accordance with an added feature of the invention, the piston pin locking ring is a slotted circlip or snap ring. In a further preferred embodiment, the profiled stop pin has an annular tightening surface and the tightening pin has an annular tightening surface.

The novel method ensures that the piston pin locking ring can be introduced into the pin bore without contact and without contacting the inner wall of the pin bore and is brought to the desired position. This avoids damage to the inner surface of the pin bore and prevents subsequently occurring engine problems from the beginning.

With the above and other objects in view there is also provided, in accordance with the invention, a device for inserting a piston pin locking ring into a locking groove of a pin bore of a piston, the apparatus comprising:

a tightening apparatus for radially pre-tightening and reducing the piston pin locking ring such that an outer diameter of the piston pin locking ring is smaller than an inner diameter of the pin bore;

means for holding and fixing the piston pin locking ring in the pre-tightened state and for transferring and introducing the pre-tightened piston pin locking ring into the pin bore, the holding and fixing means including a stop pin formed with a profiled stop pin tightening surface and a tightening pin with a profiled tightening pin tightening surface; and

said stop pin and said tightening pin being configured to cooperate to hold and fix the piston pin locking ring between said tightening surfaces in a pre-tightened state, and to introduce the piston pin locking ring into the pin bore in a contactless manner substantially without contacting an inner wall of the pin bore.

The novel device ensures that the piston pin locking ring can be introduced into the pin bore in a contactless manner in the mentioned protective manner that avoids a relieving of tension.

Advantageous means for a better takeup and fixing of the piston pin locking ring are ensured in that the stop pin and/or the tightening pin has/have a smaller outer diameter than the inner diameter of the tightening apparatus and/or of the pin bore and can be passed through the tightening apparatus at least partially, especially in a contactless manner and without contacting the inner wall of the tightening apparatus or of the pin bore.

In this connection, it is especially advantageous if the stop pin and the tightening pin cooperate with their tightening surfaces, in particular in the tightening apparatus in such a manner that the piston pin locking ring is held in the pre-tightened state and can be transferred from the tightening apparatus into the pin bore and that the stop pin and the tightening pin can be force-loaded against one another in the axial direction, in particular via drives with slip coupling. In this manner damage to the inside of the pin bore is avoided.

The receiving and fixing and introduction of the piston pin locking ring are advantageously improved in that the stop pin, the tightening pin, the tightening apparatus and/or the pin bore are arranged on a common longitudinal axis and that the stop pin, the tightening pin, the tightening apparatus and/or the pin bore are optionally arranged symmetrically relative to the longitudinal axis. This ensures secure guidance of the piston pin locking ring.

Constructively advantageous embodiments of the apparatus that facilitate a guiding and a movement of the machine parts are provided in that the stop pin and/or the tightening pin are arranged so that they can move in both directions along and parallel to the longitudinal axis. In accordance with a further advantageous feature of the invention, the stop pin can be guided and introduced along the longitudinal axis from one side of the tightening apparatus to the tightening apparatus, in particular to the middle of the tightening apparatus, and/or that the tightening pin can be guided and introduced along the longitudinal axis from the other, opposite side of the tightening apparatus to the tightening apparatus, in particular to the middle of the tightening apparatus.

In accordance with another feature of the invention, the stop pin follows a fully defined movement path which guides the stop pin through the pin bore to the tightening apparatus, especially to its middle, and back. This provides for flexibility during use and the greatest possible freedom of movement.

In accordance with an again an added feature of the invention, the a movement path is set for and assigned to the tightening pin which guides the tightening pin in a first step to the tightening apparatus, especially to its middle, and in a subsequent further step through the tightening apparatus into the pin bore up to the locking groove and back.

In accordance with a concomitant feature of the invention, the tightening apparatus is composed of two half shells or it is a conical matrix.

Other features which are considered as characteristic for the invention are set forth in the appended claims.

Although the invention is illustrated and described herein as embodied in process and apparatus for inserting a piston pin locking ring, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF SEVERAL VIEWS OF THE DRAWINGS

FIG. 1 to FIG. 6 are schematic views of the apparatus representing a sequence of steps in the process according to the invention;

FIG. 7 is a detailed view of the piston pin locking ring according to FIG. 6 inserted in the circlip groove in the piston pin bore;

FIG. 8A is an elevational view of a tightening apparatus consisting of two half shells; and

FIG. 8B is an elevational view and a section through a tightening apparatus in the form of a conical matrix.

### DETAILED DESCRIPTION OF THE INVENTION

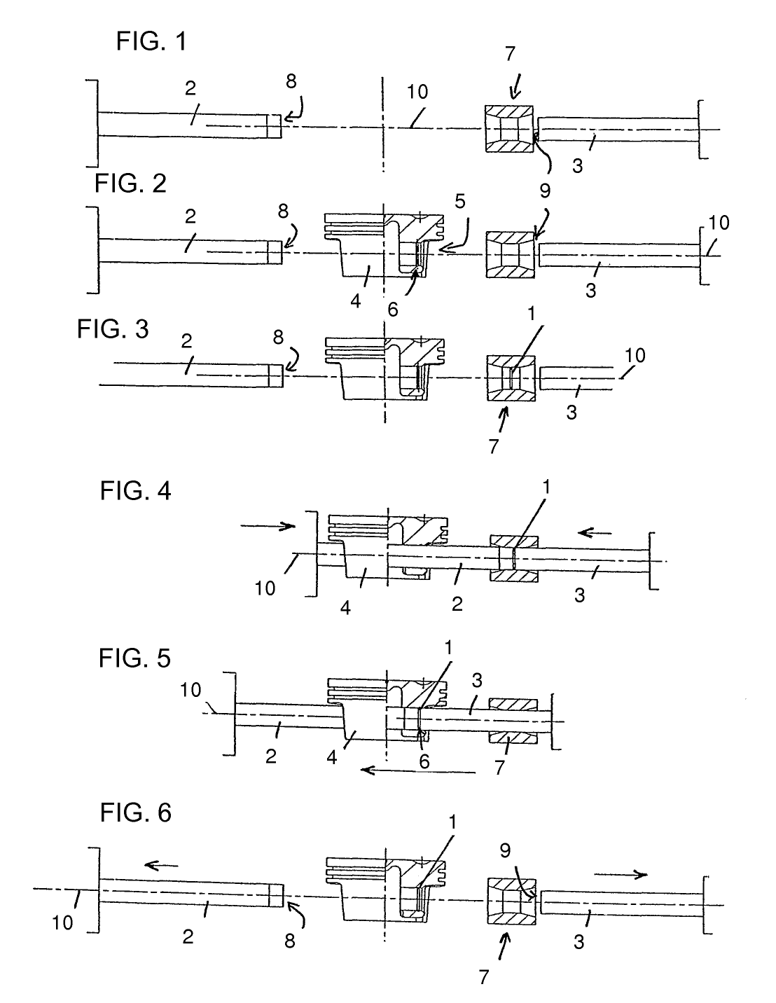

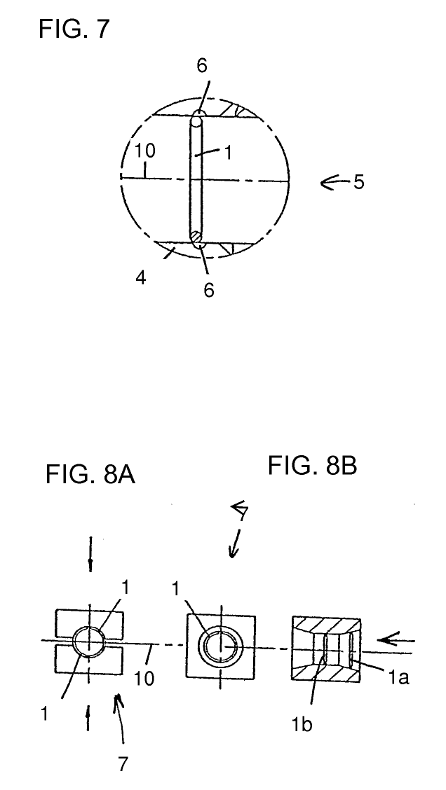

Referring now to the figures of the drawing in detail and first, particularly, to FIGS. 1 to 6 thereof, the apparatus according to the invention includes a tightening apparatus 7 for the radial pre-tightening and/or reducing of a piston pin locking ring 1 (preferably a circlip or a slotted snap ring) and for reducing the outer diameter of the piston pin locking ring 1 in such a manner that its outer diameter becomes smaller than an inner diameter of a pin bore 5 formed in a piston 4.

Furthermore, means are shown for holding and fixing piston pin locking ring 1. The holding means include a stop pin 2 with an annularly profiled stop pin tightening surface 8 adapted to the shape of piston pin locking ring 1, and a tightening pin 3 with a tightening pin tightening surface 9 that also has an annular profile and is also adapted to the diameter of piston pin locking ring 1. The ring profile formed in tightening surfaces 8 and 9 has the diameter of a piston pin locking ring 1 in the pre-tightened state and has a substantially semicircular cross section. Thus, an annular, trough-shaped groove runs in tightening surfaces 8 and 9.

FIG. 2 shows the apparatus of the invention interacting with a piston 4 and a pin bore 5.

The stop pin 2, the tightening pin 3, the tightening apparatus 7, and the pin bore 5 are arranged on a common longitudinal axis 10 and aligned and arranged symmetrically relative to this longitudinal axis.

The pin bore 5 for running the piston pin through runs through the entire upper area of piston 4.

The stop pin 2 and the tightening pin 3 have the same diameter and have an outer diameter that is somewhat smaller than the smallest inner diameter of the tightening apparatus 7 and/or of the pin bore 5.

In this manner the stop pin and the tightening pin 3 can be passed through the pin bore 5 and through the tightening apparatus 7 without contact and without contacting the inner wall of tightening apparatus 7 or of pin bore 5. Damage to the inner surfaces, in particular to the inner surface of pin bore 5, is avoided in this manner.

In FIG. 3 a piston pin locking ring 1 is already inserted into the tightening apparatus 7. This piston pin locking ring 1 can be inserted, for example, via a ring magazine or a loading cassette into tightening apparatus 7.

FIGS. 8A and 8B show exemplary embodiments of the tightening apparatus 7. FIG. 8A shows a tightening apparatus 7 consisting of two half shells surrounding the piston pin locking ring 1. FIG. 8B shows a tightening apparatus 7 in the form of a conical matrix. FIG. 8B also shows how a piston pin locking ring 1a with a rather large outer diameter is inserted into tightening apparatus 7 and how its outside diameter is reduced. The tightening apparatus 7 is formed with a recess with a tapering, conical cross section that leads into a cylindrical center. During the insertion of the piston pin locking ring 1 the outer diameter of the piston pin locking ring 1 is constantly reduced in this manner until it corresponds to the inner diameter of the cylindrical middle range and to the piston pin locking ring 1b. The piston pin locking rings 1 to be inserted are slotted circlips or snap rings.

The goal is to transfer the piston pin locking ring compressed in such a manner and radially pre-tightened in accordance with FIG. 3 into the interior of pin bore 5 to the position provided for it. The correct and desired position is given by the formation of an annular locking groove 6, or circlip groove 6, on the inner surface of pin bore 5. The piston pin locking ring 1 can engage into it and relax again at least partially.

FIG. 4 shows the movement paths of stop pin 2 and of tightening pin 3. Stop pin 2 and tightening pin 3 can be arranged so that they can move in both directions along and parallel to a longitudinal axis 10.

Stop pin 2 moves from left to right through pin bore 5 to the middle of tightening apparatus 7. In the same manner, tightening pin 3 moves coming from the right toward the left, also to the middle of tightening apparatus 7. Stop pin 2 coming from the left and tightening pin 3 coming from the right strike inside or in the interior of tightening apparatus 7 with their tightening surfaces 8, 9 against piston pin locking ring 1. Piston pin locking ring 1 is received by the profile grooves of the tightening surfaces. Stop pin 2 and tightening pin 3 cooperate in such a manner that that piston pin locking ring 1 is held and fixed between tightening surfaces 8, 9 in this pre-tightened state and can be transferred without changing its outer diameter away from tightening apparatus 7 into pin bore 5. Stop pin 2 and tightening pin 3 are force-loaded against one another via drives with slip coupling in the axial direction of longitudinal axis 10. The guiding of piston pin locking ring 1 takes place under constant pressure loading of piston pin locking ring 1 so that a falling out of piston pin locking ring 1 is avoided.

FIG. 5 shows the further movement of the stop pin 2 and of the tightening pin 3.

Stop pin 2 moves back to the left in the direction of its initial position and stops its movement as soon as its tightening surface 8 has arrived in the area of the locking groove 6. The tightening pin 3 continues its movement left, is guided through the tightening apparatus 7 and penetrates coming from the right into the pin bore 5. Its movement is also stopped in the area of the locking groove 6. In this manner the piston pin locking ring 1 is placed directly at the desired position, namely, directly over the locking groove 6.

FIG. 6 schematically shows the last step of the process in which the stop pin 2 and the tightening pin 3 return into their initial positions. In this manner the radially pre-tightened piston pin locking ring 1 is freed and relaxes and springs into the locking groove 6. Thus, as a result of this relaxing and loosening of the tightening force, the piston pin locking ring 1 is thus firmly fixed in the desired position.

It is primarily important that the introduction of the piston pin locking ring 1, in particular through the pin bore 5, is carried out in a contactless manner and without the piston pin locking ring 1 contacting the inner wall of the pin bore 5.

The important process step is therefore a radial pre-tightening and a reduction of the outside diameter of the piston pin locking ring 1 in such a manner that the outer diameter of the piston pin locking ring 1 is smaller than the inner diameter of the pin bore 5.

The piston pin locking ring 1 is thus engaged in the right-hand locking groove 6 and the left locking groove 6 remains free. In a next step a piston pin is passed from the left into and through the pin bore 5 and through the piston pin locking ring 1 and fixed on its left side with another piston pin locking ring 1.

1. A method of inserting a piston pin locking ring into a locking groove of a pin bore of a piston, the method which comprises:
providing means for receiving, holding, and fixing the piston pin locking ring in a pre-tightened state and for transferring and introducing the pre-tightened piston pin locking ring into the pin bore, the means including a stop pin with a profiled stop pin tightening surface, and a tightening pin with a profiled tightening pin tightening surface;
radially pre-tightening and reducing a size of the piston pin locking ring until an outside diameter of the piston pin locking ring is smaller than an inner diameter of the pin bore;
holding and fixing the piston pin locking ring in a pre-tightened state between the tightening surface of the stop pin and the tightening surface of the tightening pin;
inserting the piston pin locking ring in the pre-tightened state into the pin bore substantially without contacting an inner wall of the pin bore, and moving the piston pin locking ring into position inside the pin bore at the locking groove formed in the pin bore; and
subsequently relieving and freeing the piston pin locking ring by relaxing and loosening a tightening force and allowing the piston pin locking ring to spring into the locking groove and to become fixed in place.

2. The method according to claim 1, wherein the piston pin locking ring is a slotted circlip.

3. The method according to claim 1, wherein the profiled stop pin has an annular tightening surface and the tightening pin has an annular tightening surface.

4. A device for inserting a piston pin locking ring into a locking groove of a pin bore of a piston, the apparatus comprising:
a tightening apparatus for radially pre-tightening and reducing the piston pin locking ring such that an outer diameter of the piston pin locking ring is smaller than an inner diameter of the pin bore;
means for holding and fixing the piston pin locking ring in the pre-tightened state and for transferring and introducing the pre-tightened piston pin locking ring into the pin bore, the holding and fixing means including a stop pin formed with a profiled stop pin tightening surface and a tightening pin with a profiled tightening pin tightening surface; and
said stop pin and said tightening pin being configured to cooperate to hold and fix the piston pin locking ring between said tightening surfaces in a pre-tightened state, and to introduce the piston pin locking ring into the pin bore in a contactless manner substantially without contacting an inner wall of the pin bore.

5. The apparatus according to claim 4, wherein the piston pin locking ring is a slotted circlip.

6. The apparatus according to claim 4, wherein said tightening surface of said profiled stop pin is an annular tightening surface and said tightening surface of said tightening pin is an annular tightening surface.

7. The apparatus according to claim 4, wherein at least one of said stop pin and said tightening pin has a smaller outer diameter than an inner diameter of said tightening apparatus and/or of the pin bore formed in the piston and wherein the stop pin and/or the tightening pin is configured to be passed through said tightening apparatus, at least partially, or through the pin bore in the piston.

8. The apparatus according to claim 7, wherein said tightening pin is formed with a diameter configured to traverse said tightening apparatus substantially without contacting an inner wall of said tightening apparatus.

9. The apparatus according to claim 7, wherein said stop pin is formed with a diameter configured to traverse the pin bore formed in the piston substantially in a contactless manner.

10. The apparatus according to claim 4, wherein tightening surfaces of said stop pin and said tightening pin are configured to cooperate with one another to hold the piston pin locking ring in the pre-tightened state and to transfer the piston pin locking ring from said tightening apparatus into the pin bore, and wherein said stop pin and said tightening pin can be force-loaded against one another in an axial direction thereof.

11. The apparatus according to claim 10, which comprises drives with slip coupling for force-loading said stop pin and said tightening pin against one another in the axial direction.

12. The apparatus according to claim 10, wherein said stop pin and said tightening pin are configured to cooperate with one another in said tightening apparatus.

13. The apparatus according to claim 4, wherein said stop pin, said tightening pin, said tightening apparatus, and said pin bore are disposed on a common longitudinal axis.

14. The apparatus according to claim 13, wherein said stop pin, said tightening pin, said tightening apparatus, and said pin bore are arranged symmetrically relative to the longitudinal axis.

15. The apparatus according to claim 13, wherein said stop pin and said tightening pin are movably disposed in both directions along and parallel to the longitudinal axis.

16. The apparatus according to claim 13, wherein said stop pin is guided and introduced along the longitudinal axis from one side of said tightening apparatus to said tightening apparatus, and said tightening pin is guided and introduced along the longitudinal axis from an opposite side of the tightening apparatus to said tightening apparatus.

17. The apparatus according to claim 16, wherein said stop pin is movably disposed to be guided to a middle of said tightening apparatus and said tightening pin is movably disposed to be guided from the opposite side to the middle of the tightening apparatus.

18. The apparatus according to claim 4, wherein said stop pin is movably disposed along a predefined movement path, and wherein said stop pin is reversibly guided through the pin bore and to said tightening apparatus.

19. The apparatus according to claim 4, wherein said tightening pin is movably disposed along a predefined movement path, and wherein said tightening pin is guided, in a first step, to said tightening apparatus, and in a subsequent step through said tightening apparatus into the pin bore up to the locking groove and back.

20. The apparatus according to claim 4, wherein said tightening apparatus is formed of two half shells or said tightening apparatus is a conical matrix.
